(19) United States
(12) Patent Application Publication
(10) Pub. No.: US 2007/0130575 A1
(43) Pub. Date: Jun. 7, 2007

(54) Optical drive external enclosure

(76) Inventor: David Chen, Taipei (TW)

Correspondence Address: LIN & ASSOCIATES INTELLECTUAL PROPERTY, P.O. BOX 2339, SARATOGA, CA, 95070-0339, US

(21) Appl. No.: 11/293,737

(22) Filed: Dec. 2, 2005

(51) Int. Cl. G11B 33/02

(52) U.S. Cl. 720/600

(57) ABSTRACT

An optical drive external enclosure includes an upper shell, a lower shell, a front panel, and a rear panel, which are assembled together using clip-on elements and interlock elements, without using any conventional bolts and screws so that the assembling time and thus the manufacturing cost can be considerably reduced.

### BACKGROUND OF THE INVENTION

1. Field of the Invention

The present invention relates to an optical drive external enclosure, and in particular to an optical drive external enclosure that can be quickly assembled by means of clip-on elements and interlock elements.

2. The Prior Arts

Conventional optical drives, such as CD-ROM and DVD drives, are fitted in standard 5″ computer drive bays. The optical drives are rectangular shaped, including an optical drive external enclosure, a read/write module and a disk loader. The optical drive external enclosure is usually assembled with many bolts or screws. Thus the assembling cost is a major item in the cost structure.

Later, external optical drives are introduced by notebook and laptop computer manufacturers, which are independent boxes connected to the host computers through cables, and are provided with independent power supplies. These portable drives can be carried with the user on a business trip, and allow the user to use the stored data as soon as the drives are connected to other computers. These external drives are elegant looking but too bulky for hand carrying, plus the fact that these portable drives still need to be assembled with many screws.

Furthermore, the optical drive external enclosure is still the conventional type that relies on a movable load tray to pick up the disk, so the structure and size of the optical drive is very much similar to those of the conventional devices without drastic changes.

Based on these aspects, it is desired to provide an optical drive external enclosure, which can substantially reduce or obviate the limitations and disadvantages of the prior art.

### SUMMARY OF THE INVENTION

The primary object of the present invention is to provide an optical drive external enclosure that is suited for DVD burners and other optical disk writers with small size and maximum portability.

The second object of the present invention is to provide an optical drive external enclosure that can be easily assembled using clip-on elements and interlock elements with adequate sturdiness.

The third object of the present invention is to provide an optical drive external enclosure that can be easily assembled using economical means to replace the conventional bolts or screws.

To attain the above-mentioned objects, an optical drive external enclosure in accordance with comprises an upper shell, a lower shell, a front panel and a rear panel, which are assembled together using clip-on elements and interlock elements.

A first bracket is embedded inside the upper shell and has multiple interlock elements formed on a front section of the first bracket, and multiple tabs formed on an indented rear section of the first bracket.

A second bracket is also embedded inside the lower shell and has multiple interlock elements formed on a front section of the second bracket, and multiple tabs formed on an indented rear section of the second bracket.

When the upper and lower shells are coupled with each other, a basic external enclosure is formed, which has a front opening and a rear opening for attachment of the front panel and the rear panel, respectively.

The front panel is fitted in the front opening after the upper and lower shells are coupled together. The front panel has multiple interlock elements on an upper edge, which are to be fitted with the corresponding interlock elements on the first bracket. The front panel also has multiple interlock elements on a lower edge to be fitted with the corresponding interlock elements on the second bracket.

The rear panel is fitted in the rear opening after the upper and lower shells are coupled together. The rear panel is provided with two rows of support clips: the clip-on elements on an upper row are to be fitted with the tabs on a backside of the first bracket, and the clip-on elements on a lower row are to be fitted with the tabs on a backside of the second bracket.

Since the optical drive external enclosure of the present invention is assembled with clip-on elements and interlock elements, this allows a drive to be quickly assembled in the enclosure without using any bolts or screws.

This external enclosure is provided with a disk intake and ejection module, such that the disk is to be operated in the same manner as an ATM card. This module is to replace the movable disk tray used in conventional drives. Therefore, this external enclosure can be created with a small size.

The front panel has a horizontal cut for installing buttons and a long narrow straight cut across an upper portion that allows a disk to be inserted into the optical drive.

These along with other features of novelty, which characterize the invention, are pointed out with particularity in the claims annexed to and forming a part of this disclosure. For a better understanding of the invention, the operating advantages and the specific objectives attained by its uses, references should be made to the accompanying drawings and descriptive matter illustrated in preferred embodiments of the invention.

### BRIEF DESCRIPTION OF THE DRAWINGS

FIG. 1 is a perspective view of an optical drive external enclosure in accordance with the present invention;

FIG. 2 is an exploded view of the optical drive external enclosure of the present invention;

FIG. 3 is a perspective view showing the assembling of a front panel of the present invention; and

FIG. 4 is a top view showing the front panel assembled on the optical drive external enclosure of the present invention.

### DETAILED DESCRIPTION OF THE PREFERRED EMBODIMENT

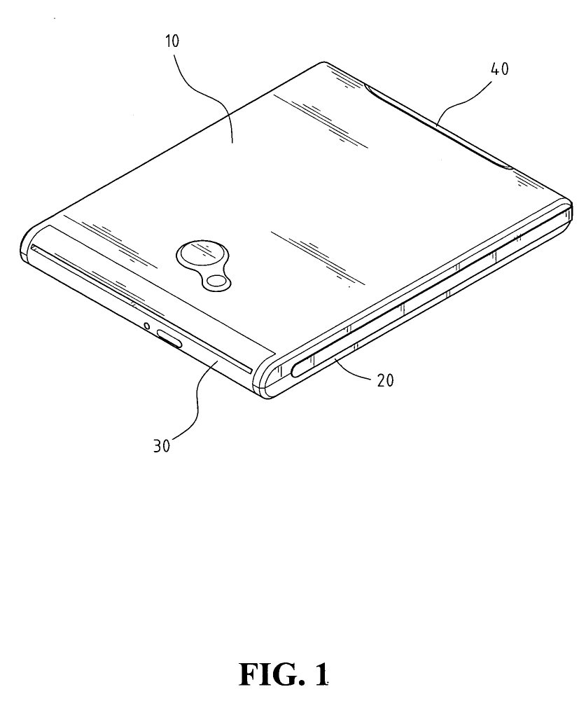

Referring to FIG. 1, an optical drive external enclosure comprises an upper shell 10, a lower shell 20, a front panel 30 and a rear panel 40, which are assembled together using clip-on elements and interlock elements. The upper and lower shells 10, 20 are first coupled with each other; then, the front panel 30 is assembled thereto through a front opening of the enclosure, whereas the rear panel 40 is assembled thereto through a rear opening of the enclosure.

The upper and lower shells 10, 20 are made of metal or plastic materials; but to reduce the cost, it is preferable to use plastic materials. The front panel 30 and the rear panel 40 are typically made of plastic materials.

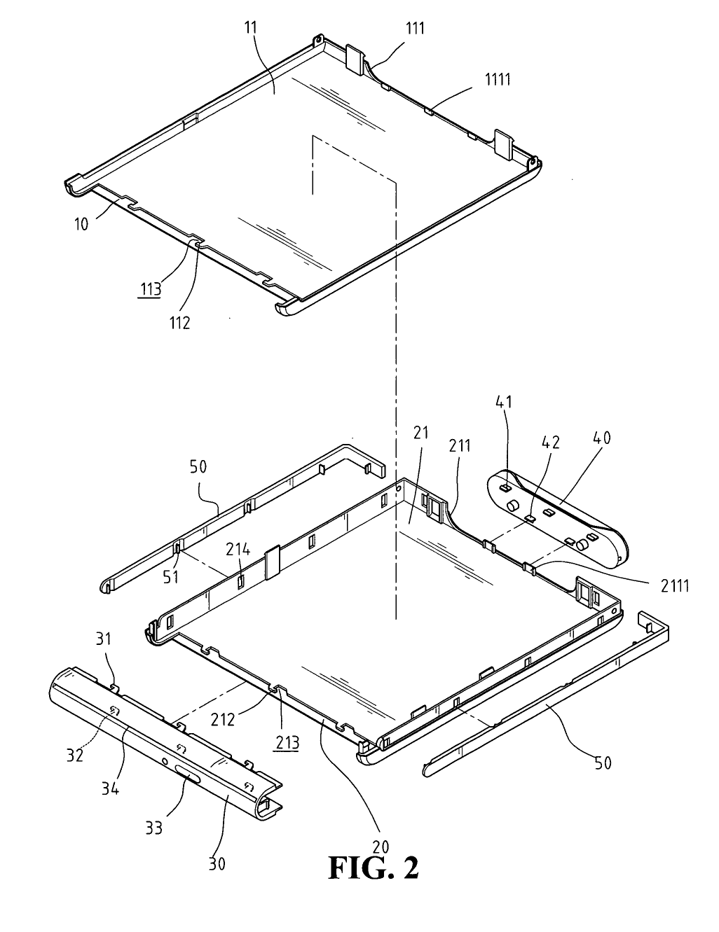

Referring to FIG. 2, a first bracket 11 is embedded inside the upper shell 10 and has three tabs 1111 formed on indented rear section 111 of the first bracket 11. However, the number of tabs 1111 and their positions can be changed depending on actual design.

The first bracket 11 also has three male interlock elements 112 and three female interlock elements 113 on a front section thereof. The number of the male interlock elements 112 and the female interlock elements 113 and their positions can be changed depending on actual design.

A second bracket 21 is also embedded inside the lower shell 20 and has two tabs 2111 formed on indented rear section 211 of the second bracket 21. The number of tabs 2111 can be changed depending on actual design.

The second bracket 21 also has three male interlock elements 212 and three female interlock elements 213 on a front section thereof. The number of the male interlock elements 212 and the female interlock elements 213 can be changed depending on actual design.

The front panel 30 has three male and female interlock elements 31 on an upper edge, and three male and female interlock elements 32 on a lower edge thereof, where the interlock elements 31 on the upper edge are to be fitted with the corresponding interlock elements 112, 113 on the first bracket 11, and the interlock elements 32 on the lower edge are to be fitted with the corresponding interlock elements 212, 213 on the second bracket 21. The front panel 30 is fitted in the front opening of the enclosure after the upper and lower shells 10, 20 are coupled with each other. The number of the interlock elements 31, 32 can be changed depending on actual design.

The rear panel 40 has three clip-on elements 41 on an upper row and two clip-on elements 42 on a lower row thereof. The clip-on elements 41 on the upper row are to be fitted with the corresponding tabs 1111 on the first bracket 11, and the clip-on elements 42 on the lower row are to be fitted with corresponding tabs 2111 on the second bracket 21. The rear panel 40 is fitted in the rear opening of the enclosure after the upper and lower shells 10, 20 are coupled with each other.

After the upper and lower shells 10, 20 are coupled with each other, a trim piece 50 is then attached on each side of the enclosure. Each trim piece 50 has five horizontal clips 51 on a backside for fitting with corresponding holes 214 on the second bracket 21. The number of the clips 51 and holes 214 can be changed to match actual design.

The optical drive external enclosure of the present invention is assembled using the above-mentioned clip-on elements and interlock elements instead of the conventional bolts or screws. The sturdiness of the optical drive external enclosure is comparable to that of the conventional drive enclosure, but its assembling time and manufacturing cost can be greatly reduced.

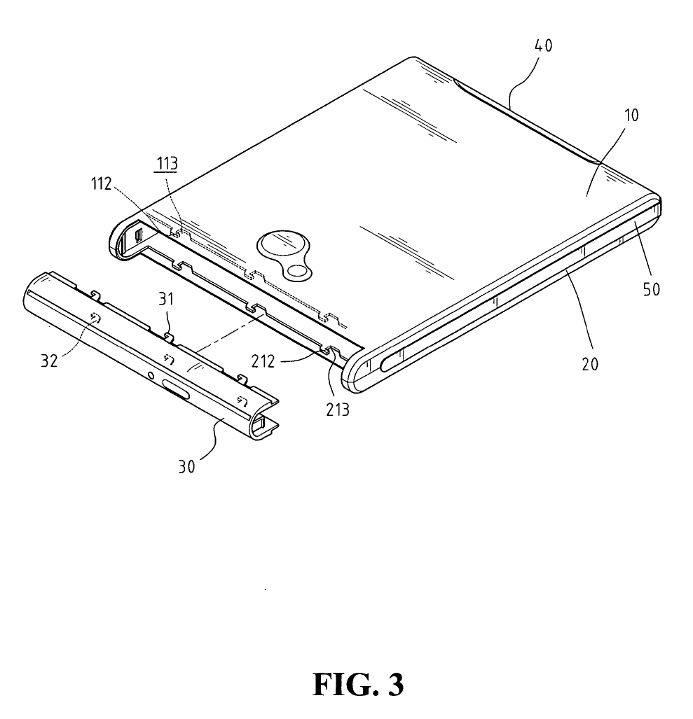

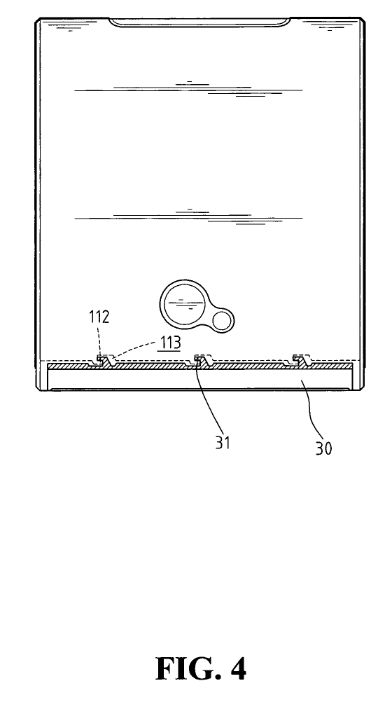

Referring to FIGS. 2-4, the assembling procedure of the optical drive external enclosure is illustrated as follows: first, the first bracket 11 is embedded inside the upper shell 10; the second bracket 21 is embedded inside the lower shell 20 likewise; then, the upper shell 10 is placed over the lower shell 20 to form a basic enclosure structure; the two trim pieces 50 are attached onto two sides of the lower bracket 21; the rear panel 40 is fitted onto the rear opening of the enclosure; and finally, the front panel 30 is fitted onto the front opening of the enclosure to complete the assembling.

The front panel 30 comprises a horizontal cut 33 for installing buttons (not labeled) and a long narrow straight cut 34 across an upper portion of the front panel 30. The external enclosure is designed to support a unique disk intake and ejection module (not shown), which allows the disk to be used in a manner just like an ATM card. The disk intake and ejection module is to replace the movable disk tray used in conventional devices. Therefore, the physical size of the external enclosure can be considerably reduced as compared to the conventional enclosures.

The new optical drive external enclosure is suited for CD-ROM, CD-RW, DVD-RW burners or other optical disk writers. The optical drive external enclosure provides maximum portability and elegant design at the same time, while it is able to support different communication interfaces, such as USB, IEEE 1394.

Although the present invention has been described with reference to the preferred embodiments thereof, it is apparent to those skilled in the art that a variety of modifications and changes may be made with regard to different forms and shapes without departing from the spirit and scope of the present invention which is intended to be defined by the appended claims.

What is claimed is:

1. An optical drive external enclosure, comprising:
an upper shell comprising a first bracket embedded therein, where multiple tabs are formed on an indented rear section of the first bracket, and multiple male and female interlock elements are formed on a front section of the first bracket;
a lower shell comprising a second bracket embedded therein, where multiple tabs are formed on an indented rear section of the second bracket, and multiple male and female interlock elements are formed on a front section of the second bracket;
a front panel having multiple male and female interlock elements on an upper edge, and multiple male and female interlock elements on a lower edge thereof, which are fitted with the corresponding interlock elements on the first bracket and the corresponding interlock elements on the second bracket, respectively; and
a rear panel having multiple clip-on elements on a backside thereof, where the clip-on elements on an upper row are fitted with the corresponding tabs on the first bracket, and the clip-on elements on a lower row are fitted with the corresponding tabs on the second bracket.

2. The optical drive external enclosure as claimed in claim 1, wherein a trim piece is attached onto each side of the second bracket.

3. The optical drive external enclosure as claimed in claim 2, wherein each trim piece has multiple horizontal clips on a backside for fitting with corresponding holes on the second bracket.

4. The optical drive external enclosure as claimed in claim 1, wherein the front panel has a horizontal cut for installing buttons.

5. The optical drive external enclosure as claimed in claim 1, wherein the front panel has a long narrow straight cut across an upper portion thereof.

6. The optical drive external enclosure as claimed in claim 1, wherein the enclosure is provided with a disk intake and ejection module.
